(19) United States
(12) Patent Application Publication
(10) Pub. No.: US 2021/0148433 A1
(43) Pub. Date: May 20, 2021

(54) SHOCK ABSORBER AND LAUNDRY TREATMENT DEVICE COMPRISING SHOCK ABSORBER

(71) Applicant: QINGDAO HAIER DRUM WASHING MACHINE CO., LTD., Qingdao, Shandong (CN)

(72) Inventors: Zhiqiang ZHAO, Qingdao (CN); Sheng XU, Qingdao (CN); Yang LI, Qingdao (CN)

(73) Assignee: QINGDAO HAIER DRUM WASHING MACHINE CO., LTD., Qingdao (CN)

(21) Appl. No.: 16/632,969

(22) PCT Filed: Jun. 29, 2018
(86) PCT No.: PCT/CN2018/093734

§ 371 Date: Jan. 22, 2020

(30) Foreign Application Priority Data
Jul. 28, 2017 (CN) 201710633544.5

(51) Int. Cl. F16F 13/10; F16F 15/02; D06F 37/22; D06F 23/02

(52) U.S. Cl. CPC F16F 13/105; F16F 15/022; D06F 37/22; D06F 23/02; F16F 2224/025; F16F 2234/02; F16F 2222/12; F16F 2230/0005; F16F 2230/183; F16F 2232/08; F16F 2228/066

(57) ABSTRACT

A shock absorber, including: a sleeve, the sleeve having a first chamber; a plunger, the plunger slidably inserted into the first chamber of the sleeve; the first chamber is provided therein with a liquid capsule, and an open end of the liquid capsule is fixedly connected to the plunger, the plunger provided therein with a second chamber; the second chamber is provided with damping holes at an end near the liquid capsule; an inner chamber of the liquid capsule and/or the second chamber is filled with fluid; a valve plate group including at least one valve plate, and the valve plate group at least covering one damping hole. As the stroke of the plunger within a cylinder increases, the damping force received also increases, and the extent of vibration may be effectively reduced when a washing machine vibrates violently.

### FIELD OF THE INVENTION

The present disclosure relates to the technical field of washing machines, and in particular to a shock absorber and a laundry treatment device including the same.

### BACKGROUND OF THE INVENTION

Washing machines are clean electrical appliances that use electrical energy to wash laundries. With the acceleration of the pace of life and people's high requirements on living comfort, washing machines have become indispensable household appliances in people's daily lives. However, significant vibrations and noises are produced in the washing machine during the washing, rinsing and spinning processes, which brings some inconveniences to people's normal lives.

For solving the problem of excessive vibrations and noises during the operation of the washing machine, a “damper for washing machine” is disclosed in Chinese patent application for invention with a publication number CN1718902A. Specifically, the damper for washing machine includes a cylinder and a piston rod inserted in the cylinder. An end of the piston rod is provided with a piston, and the piston divides the cylinder into an upper cylinder chamber and a lower cylinder chamber. In addition, the piston is also provided with a throttling passage that communicates with the upper cylinder chamber and the lower cylinder chamber. Fluid is injected into the upper cylinder chamber and the lower cylinder chamber, and during a sliding movement of the plunger, the fluid passes through the throttling passage and flows between the upper cylinder chamber and the lower cylinder chamber, thereby generating fluid damping and achieving the purpose of reducing vibrations of the washing machine. However, when the piston rod is reciprocating in the cylinder, volumes of the upper cylinder chamber and the lower cylinder chamber are correspondingly increased or decreased, so that the damper is subjected to a substantially invariable damping force in the entire moving stroke of the piston rod. Therefore, the damper for washing machine cannot increase the damping force generated by the damper with an increase in the moving stroke of the piston rod relative to the cylinder; especially for strong vibrations, the shock absorbing effect is poor.

Accordingly, there is a need in the art for a new shock absorber to solve the above problems.

### SUMMARY OF THE INVENTION

In order to solve the above problems in the related art, that is, in order to solve the problems that a damping force is invariable in existing shock absorbers in a working process and the shock absorbing effect is poor during strong vibration, the present disclosure provides a shock absorber, which includes: a sleeve having a first chamber; and a plunger which is slidably inserted into the first chamber of the sleeve; wherein the first chamber is provided therein with a liquid capsule, and an open end of the liquid capsule is fixedly connected to the plunger; the plunger is provided therein with a second chamber which is provided with a plurality of damping holes at an end near the liquid capsule, and an inner chamber of the liquid capsule and/or the second chamber is filled with a fluid; wherein the shock absorber further includes at least one valve plate group including at least one a valve plate, the valve plate group covers at least one of the damping holes, and wherein the valve plate group is capable of opening or closing the damping hole as the fluid flows.

In a preferred technical solution of the above shock absorber, the end of the second chamber near the liquid capsule is fixedly connected to or integrally provided with a partition, and the plurality of damping holes are disposed on the partition.

In a preferred technical solution of the above shock absorber, a thickness of the valve plate group gradually decreases from a center to an edge thereof.

In a preferred technical solution of the above shock absorber, the valve plate group includes a plurality of valve plates, and the plurality of valve plates are stacked with each other in a direction away from the partition.

In a preferred technical solution of the above shock absorber, a surface area of each valve plate in the valve plate group gradually decreases in a direction away from the partition.

In a preferred technical solution of the above shock absorber, a projection of each of the valve plates in the valve plate group on the partition covers at least one of the damping holes.

In a preferred technical solution of the above shock absorber, each of the valve plates has a fan-blade structure or a quincunx-shaped structure.

In a preferred technical solution of the above shock absorber, the shock absorber includes two said valve plate groups, and the two valve plate groups are disposed at two sides of the partition respectively.

In a preferred technical solution of the above shock absorber, the valve plate group is provided with a through hole, and the valve plate group is connected to the partition via a fastener passing through the through hole.

The present disclosure also provides a laundry treatment device, which includes a housing and a washing drum disposed in the housing, and the washing drum is supported in the housing through a plurality of shock absorbers, wherein at least one of the shock absorbers is the shock absorber according to any one of the above technical solutions.

It can be understood by those skilled in the art that in a preferred technical solution of the present disclosure, the shock absorber includes a sleeve, a plunger, a liquid capsule, and at least one valve plate group. The sleeve has a first chamber, and the plunger is slidably inserted into the first chamber of the sleeve. The liquid capsule is disposed in the first chamber. The open end of the liquid capsule is fixedly connected to the plunger. The plunger has a second chamber. The end of the second chamber near the liquid capsule is provided with a plurality of damping holes. An inner chamber of the liquid capsule and/or the second chamber is filled with a fluid. The valve plate group includes at least one valve plate. In an assembled state, the valve plate group covers at least one damping hole and the valve plate group is capable of opening or closing the damping hole as the fluid flows.

By disposing a liquid capsule having an open end fixedly connected to the plunger in the first chamber, the plunger will stretch or compress the liquid capsule during a reciprocating movement of the plunger, whereby the liquid capsule will provide an elastic force; as the stroke of the plunger in the sleeve increases, the elastic force that the plunger is subjected to also increases, which enhances the shock absorbing effect of the shock absorber. At the same time, the arrangement of the second chamber in the plunger enables the volume of the second chamber to remain unchanged during a telescopic movement of the plunger along the sleeve. When the plunger is in a compression movement, the fluid in the second chamber will gradually increase, which will gradually increase the pressure in the second chamber. Therefore, a greater force will be required for the fluid in the first chamber to enter the second chamber, so that the damping force generated by the shock absorber is greater; when the plunger is in a stretching movement, the fluid in the second chamber will enter the first chamber, and the fluid in the second chamber will gradually decrease so that the negative pressure in the second chamber increases, which causes the damping force applied to the fluid in the second chamber when entering the first chamber to become larger. Therefore, in the shock absorber of the present disclosure, as the stroke of the plunger in the sleeve increases, the damping force it is subjected to also increases. That is, the greater the vibration of the washing machine is, the greater the damping force provided by the shock absorber will be. As compared with the existing dampers for a washing machine, the damping force of the shock absorber of the present disclosure is variable, and can automatically adjust according to a vibration frequency of the washing machine to form a damping force that matches with the vibration, thereby reducing vibration and noise.

Further, the valve plate group covers at least one damping hole and can open or close the damping hole as the fluid flows, so that when the washing drum has a strong vibration, the pressure generated by the shock absorber can deform the valve plate covering the damping hole so that the covered damping hole is opened and that more damping holes allow the fluid to pass through at the same time. As such, the damping force is provided more quickly when the washing drum is in a violent motion, which avoids a phenomenon that the in case of an instantaneous large impact force generated by the washing drum, the washing machine vibrates significantly due to a rigid transmission of force between the washing drum and the washing machine housing since the instantaneous damping force provided by the shock absorber is insufficient, so that the degree of vibration when the washing machine is in strong vibration is effectively reduced, and the shock absorbing effect of the shock absorber is further improved.

### BRIEF DESCRIPTION OF THE DRAWINGS

The shock absorber and the laundry treatment device including the shock absorber according to the present disclosure will be described below with reference to the accompanying drawings and in connection with a drum washing machine. In the drawings:

FIG. 1 is a schematic view of an installation position of a shock absorber for a drum washing machine according to the present disclosure;

FIG. 2 is an exploded schematic view of a shock absorber for a drum washing machine according to the present disclosure;

FIG. 3 is a schematic cross-sectional view of a shock absorber for a drum washing machine according to the present disclosure; and

FIG. 4 is a partially enlarged schematic view of FIG. 3 at position A.

### LIST OF REFERENCE SIGNS

1. shock absorber; 11. sleeve; 111. first fixing portion; 112. first chamber; 12. plunger; 121. second fixing portion; 122. second chamber; 13. partition; 131. first damping hole; 132. second damping hole; 133. third damping hole; 14. liquid capsule; 15. valve plate group; 151. first valve plate; 152. second valve plate; 153. third valve plate; 154. fastener; 2. housing; 3. drum; 4. hydraulic oil.

### DETAILED DESCRIPTION OF THE EMBODIMENT(S) OF THE INVENTION

Hereinafter, preferred embodiments of the present disclosure will be described with reference to the accompanying drawings. Those skilled in the art should understand that these embodiments are only used to explain the technical principles of the present disclosure, and are not intended to limit the scope of protection of the present disclosure. For example, although the description is given in connection with hydraulic oil in the specification, it is obvious that other forms of fluids with a certain viscosity may also be used in the present disclosure, as long as the fluid itself does not cause corrosion to the plunger and the liquid capsule.

It should be noted that in the description of the present disclosure, directional or positional relationships indicated by terms such as “center”, “upper”, “lower”, “left”, “right”, “vertical”, “horizontal”, “inner” and “outer” are based on the directions or positional relationships shown in the drawings. They are merely used for the convenience of description, and do not indicate or imply that the device or element involved must have a specific orientation, or be configured or operated in a specific orientation, and therefore they should not be construed as limiting the present disclosure. In addition, terms “first”, “second”, and “third” are only used for descriptive purposes, and should not be understood as indicating or implying relative importance.

In addition, it should also be noted that in the description of the present disclosure, terms such as “install”, “connect” and “connection” should be understood in a broad sense, unless explicitly stated and defined otherwise; for example, they may indicate a fixed connection, a detachable connection or an integral connection, or may indicate a mechanical connection or an electrical connection; or may indicate a direct connection, or an indirect connection through an intermediate medium, or an internal communication between two elements. For those skilled in the art, the specific meanings of the above terms in the present disclosure may be interpreted according to the specific circumstances.

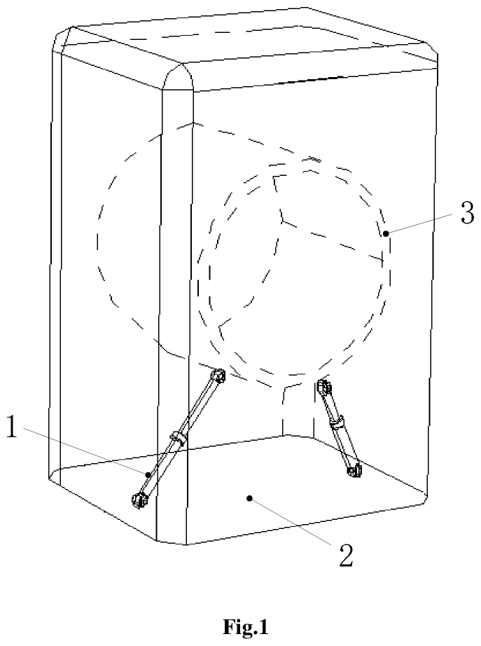

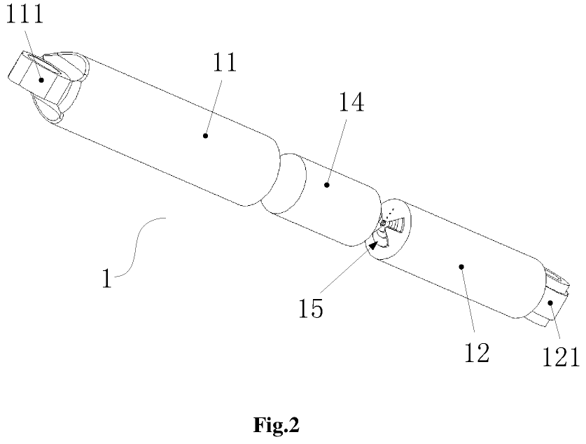

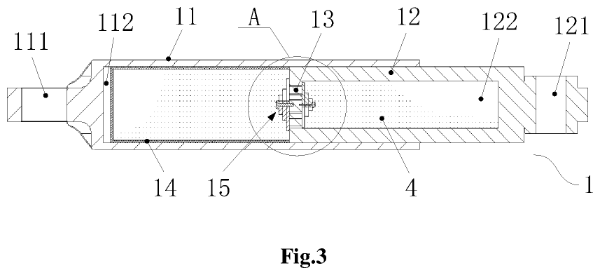

Reference is first made to FIGS. 1, 2 and 3. FIG. 1 is a schematic view of an installation position of a shock absorber for a drum washing machine according to the present disclosure; FIG. 2 is an exploded schematic view of a shock absorber for a drum washing machine according to the present disclosure; and FIG. 3 is a schematic cross-sectional view of a shock absorber for a drum washing machine according to the present disclosure.

As shown in FIG. 1, one end of a shock absorber 1 for a drum washing machine of the present disclosure is connected to a housing 2 of the drum washing machine, and the other end of the shock absorber 1 is connected to the bottom of a drum 3. When the drum 3 vibrates during operation, the shock absorber 1 can support the drum 3 and consume a vibration energy generated by the drum 3. Specifically, as shown in FIGS. 2 and 3, the shock absorber 1 mainly includes a sleeve 11, a first fixing portion 111 that is fixedly connected to a first end of the sleeve 11 (the left end of the sleeve 11 shown in FIG. 3), a plunger 12, and a second fixing portion 121 that is fixedly connected to a first end of the plunger 12 (the right end of the plunger 12 shown in FIG. 3). The sleeve 11 has a first chamber 112. In an assembled state, a second end of the plunger 12 (the left end of the plunger 12 shown in FIG. 3) is slidably inserted into the first chamber 112 of the sleeve 11 from a second end of the sleeve 11 (the right end of the sleeve 11 shown in FIG. 3). Preferably, an outer wall of the plunger 12 is slidably tightly engaged with an inner wall of the sleeve 11. The first fixing portion 111 is used to connect to the drum 3 of the washing machine, and the second fixing portion 121 is used to connect to the housing 2 of the washing machine. Of course, it can be understood that the first fixing portion 111 may also be connected to the housing 2 of the washing machine, and the second fixing portion 121 may be connected to the drum 3 of the washing machine.

With continued reference to FIG. 3, the plunger 12 is provided therein with a second chamber 122, and the second end of the plunger 12 is provided with a partition 13 integrally formed with the plunger 12. A liquid capsule 14 made of an elastic material is disposed in the first chamber 112, and a closed end of the liquid capsule 14 (the left end of the liquid capsule 14 shown in FIG. 3) abuts against the first chamber 112 of the sleeve 11, and is preferably fixedly connected to the sleeve 11. An open end of the liquid capsule 14 (the right end of the liquid capsule 14 shown in FIG. 3) is tightly connected to the second end of the plunger 12 (specifically, the partition 13) in a sealed manner A plurality of damping holes are provided in the partition 13. Hydraulic fluid 4 is injected into the inner chamber of the liquid capsule 14 and/or the second chamber 122. When the plunger 12 slides in the first chamber 112 of the sleeve 11, the hydraulic fluid 4 can pass through the damping holes and flow back and forth in the liquid capsule 14 and the second chamber 122. Specifically, the liquid capsule 14 is made of an elastic material, such as polyurethane, silicone, rubber, or the like.

The advantage of this arrangement is that, on one hand, since the open end of the liquid capsule 14 is fixedly connected to the partition 13 and the closed end of the liquid capsule 14 is fixedly connected to the sleeve 11, during a reciprocating movement of the plunger 12, the plunger 12 will stretch or compress the liquid capsule 14, and the liquid capsule 14 will therefore provide an elastic damping force. As the stroke of the plunger 12 in the sleeve 11 deviating from an equilibrium position increases, the elastic damping force it is subjected to also increases, and the damping effect of the shock absorber 1 is enhanced. On the other hand, since the liquid capsule 14 is provided in the first chamber 112 and one end of the liquid capsule 14 is connected to the plunger 12 in a sealed manner, the hydraulic oil 4 will only flow between the liquid capsule 14 and the second chamber 122 during the sliding movement of the plunger 12 relative to the sleeve 11, and there is no need to provide a dynamic seal or an oil seal between the plunger 12 and the sleeve 11 as in the related art, thereby simplifying the overall structure of the shock absorber 1, and reducing production cost and machining difficulty. In addition, since the outer wall of the plunger 12 and the inner wall of the sleeve 11 are slidably and tightly engaged, the overall structure of the shock absorber 1 is more stable, and the problem that the piston is deviated during the sliding movement and wear the inner wall of the sleeve 11 in the related art is avoided. At the same time, as compared with the existing dampers for washing machine, the shock absorber 1 of the present disclosure has the effects of simplifying the overall structure and reducing the manufacturing cost since rod support/guide mechanisms for the plunger 12 at the ends of the piston and the cylinder are not required.

It can be understood by those skilled in the art that although the partition 13 and the plunger 12 shown in FIG. 3 are integrally formed, the partition 13 and the plunger 12 may also be provided separately, that is, the partition 13 provided with a plurality of damping holes is connected to the second end of the plunger 12 in a sealed manner; the open end of the liquid capsule 14 may also be connected to the plunger in a sealed manner by means of other components. For example, the open end of the liquid capsule 14 and the second end of the plunger 12 are pressed tightly by using a press ring, or a bushing is provided between the open end of the liquid capsule 14 and the second end of the plunger 12, and the open end of the liquid capsule 14 and the second end of the plunger 12 are respectively connected to two ends of the bushing so that the open end of the liquid capsule 14 and the plunger 12 are fixedly connected; the closed end of the liquid capsule 14 may also be configured to be slidably connected to the sleeve 11; in addition, although the hydraulic oil 4 is used in a preferred embodiment in the drawings, it is obvious that it may also be replaced by other fluids.

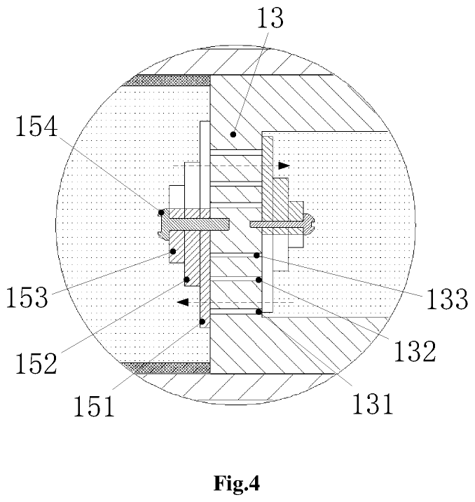

Reference is made to FIG. 3 and FIG. 4 hereinafter, wherein FIG. 4 is a partially enlarged view of FIG. 3 at position A. In a more preferred embodiment, in order to further enhance the shock absorbing effect of the shock absorber 1, especially to resist an instantaneous large impact force generated by the washing machine in case of violent motion, the shock absorber 1 is further provided with at least one valve plate group 15 which is connected to the partition 13. Each valve plate group 15 includes at least one valve plate. In an assembled state, the valve plate group covers at least one of the plurality of damping holes and is capable of opening or closing the covered damping hole as the fluid flows back and forth in the inner chamber of the liquid capsule 14 and in the second chamber 122. Specifically, during the sliding movement of the plunger 12 relative to the sleeve 11, the volume of the first chamber 112 changes to generate a pressure, and the pressure results in deformation of the valve plates in the valve plate group 15. The damping hole covered by the valve plate is opened, so that the inner chamber of the liquid capsule 14 and the second chamber 122 communicate with each other through the damping hole and a damping force is provided. Preferably, the valve plate group 15 is provided with a through hole, and the valve plate group 15 is connected to the partition 13 via a fastener 154 (such as a screw) passing through the through hole; after being connected, the valve plate group 15 may cover at least one damping hole. Specifically, the valve plate in the valve plate group 15 is made of a material that can be deformed and recovers well after deformation, such as polyetheretherketone (commonly known as PEEK), a valve plate steel of model SS716 or 7C27Mo2 made in Sweden, etc.

With continued reference to FIGS. 3 and 4, it is further preferred that two sides of the partition 13 are each provided with a valve plate group 15, and each valve plate group 15 is formed by piling up (stacking) three fan-blade shaped valve plates (see FIG. 2), i.e. a first valve plate 151, a second valve plate 152, and a third valve plate 153. Each valve plate includes three blades, and the blades of different valve plates are stacked correspondingly to form a complete fan-blade shape (see FIG. 2). For each valve plate group 15, a thickness of the valve plate group 15 gradually decreases from a center to an edge of the valve plate group 15. Specifically, surface areas of the three fan-blade shaped valve plates decrease sequentially in a direction away from the partition 13. A connection hole is provided at a circle center of each valve plate, and fasteners 154 (such as screws) pass through three through holes to connect the valve plate group 15 to the partition 13. After being connected, two sides of the partition 13 are distributed stepwise in an axial direction of the plunger 12; that is, as shown in FIG. 4, a stacked thickness in the middle of the partition 13 is the largest, and a stacked thickness at the edge of the partition 13 is the smallest. Six damping holes may be provided, and are divided into two groups corresponding to two valve plate groups 15 respectively. Each group of the damping holes includes three damping holes, i.e., a first damping hole 131, a second damping hole 132, and a third damping hole 133. At the same time, a projection of each of the valve plates in the valve plate group 15 on the partition 13 covers at least one of the corresponding three damping holes. In other words, the positions where the three damping holes are disposed in the partition 13 correspond to valve plates with different stacked thicknesses, respectively. As shown in the orientation of FIG. 4, the partition 13 is provided with six damping holes from top to bottom. The six damping holes are divided into two groups according to the relative positions to the fasteners 154. The upper three constitute a group and the lower three constitute another group, each group including the first damping hole 131, the second damping hole 132, and the third damping hole 133.

It can be clearly seen from the section lines of the valve plate group 15 that the valve plate group 15 on the left side of the partition 13 covers the three lower damping holes, and the valve plate group 15 on the right side of the partition 13 covers the upper three damping holes. For each valve plate group, the projection of the innermost first valve plate 151 on the partition 13 covers the first damping hole 131, the second damping hole 132, and the third damping hole 133, the projection of the second valve plate 152 on the partition 13 covers the second damping hole 132 and the third damping hole 133, and the projection of the outermost third valve plate 153 on the partition 13 only covers the third damping hole 133. In this way, the hydraulic oil 4 in the inner chamber of the liquid capsule 14 can flow into the second chamber 122 through the upper three damping holes when the valve plate group 15 on the right side of the partition 13 is deformed under pressure, and the hydraulic oil 4 in the second chamber 122 can flow into the inner chamber of the liquid capsule 14 through the lower three damping holes when the valve plate group 15 on the left side of the partition 13 is deformed under pressure.

For example, when a small-amplitude vibration is produced in the washing machine (such as when the drum washing machine is running stably at a high speed), the plunger 12 has a relatively small sliding stroke relative to the sleeve 11, and the pressure generated by the inner chamber of the liquid capsule 14 can only deform the valve plate at the minimum thickness of the valve plate group 15 (i.e., the first valve plate 151), whereas the valve plates at a larger thickness of the valve plate group 15 (i.e., the second valve plate 152 and the third valve plate 153) are not deformed. At this point, only the first damping hole 131 is opened, and then the hydraulic oil 4 flows back and forth between the inner chamber of the liquid capsule 14 and the second chamber 122 through the first damping hole 131 to generate a damping force. When a large-amplitude vibration is produced in the washing machine (such as when the drum washing machine is just started), the plunger 12 has a relatively large sliding stroke relative to the sleeve 11, and the pressure generated by the inner chamber of the liquid capsule 14 is sufficient to deform the valve plates at the maximum thickness of the valve plate group 15 (i.e., the first valve plate 151, the second valve plate 152, and the third valve plate 153). At this point, the first damping hole 131, the second damping hole 132 and the third damping hole 133 are simultaneously opened, and then the hydraulic oil 4 can flow back and forth between the inner chamber of the liquid capsule 14 and the second chamber 122 through the three damping holes to generate a damping force, so as to quickly offset the instantaneous impact force generated by the large-amplitude vibration.

This arrangement has the following advantage: since different numbers of damping holes are covered by the projections of different valve plates on the partition 13, when vibrations are produced in the washing machine in different situations, the valve plate group 15 is deformed to different degrees, whereby different numbers of damping holes are opened to generate a damping force corresponding to the vibration for damping, which avoids a phenomenon that the in case of an instantaneous large impact force generated by the drum 3, the washing machine vibrates significantly due to a rigid transmission of force between the washing drum and the washing machine housing 2 since the instantaneous damping force provided by the shock absorber 1 is insufficient, so that the degree of vibration when the washing machine is in strong vibration is effectively reduced, and the shock absorbing effect of the shock absorber 1 is further improved.

It should be noted herein that the thicknesses and diameters of the valve plates are not limited in this embodiment. For different models of shock absorbers 1, the thicknesses and diameters of the valve plates are not completely the same. For example, for a relatively small shock absorber 1, the thickness of the valve plate may range from a few tenths of a millimeter to several millimeters; whereas for a relatively large shock absorber 1, the thickness of the valve plate may range from several millimeters to more than ten millimeters.

In addition, it should be noted that the above-mentioned preferred arrangements of the valve plate group 15 are only used to explain the principle of the present disclosure, and are not intended to limit the scope of protection of the present disclosure. Those skilled in the art may also make corresponding adjustments to the above arrangements without departing from the principle of the present disclosure in order to adapt to a more specific application occasion. For example, the valve plate group 15 may also be provided on only one side (such as the right side) of the partition 13, and the valve plate group 15 only covers the upper three damping holes (see FIG. 4); the valve plate group 15 may also be fixed by means of a rivet or bolt-nut connection; the number of valve plates of the valve plate group 15 may also be one, two or four, and when the number of valve plates is one, the thickness of the valve plate decreases from the center to the edge so that a single valve plate has the function of being deformed differently under different vibrations; the valve plate may also be of a sheet-like structure of any other shape, as long as the structure can cover at least one damping hole, such as a quincunx-shaped valve plate, etc.; the valve plates may be set have the same thickness or any thickness; the number of damping holes may also be two, three or four, and the positions where the damping holes are disposed in the partition 13 are not limited to falling onto the same straight line, as long as the positions of the damping holes satisfy the condition that at least one damping hole is covered by the projection of each valve plate group 15 on the partition 13.

The working principle of the shock absorber 1 of the present disclosure will be briefly described below with reference to FIGS. 3 and 4. As shown in the orientation of FIG. 3, when the plunger 12 is forced to slide toward the left, the volume of the liquid capsule 14 becomes smaller, the hydraulic oil 4 is squeezed, and the inner chamber of the liquid capsule 14 generates a positive pressure. This pressure causes the valve plate group 15 on the right side of the partition 13 to be deformed, the three damping holes above the screw are opened (see FIG. 4), and then the hydraulic oil 4 flows toward the second chamber 122 through the opened damping holes. The hydraulic oil 4, when flowing toward the second chamber 122, generates a rightward damping force on the partition 13, which slows down the leftward movement of the plunger 12 and has an effect of damping. When the plunger 12 is forced to slide toward the right, the volume of the liquid capsule 14 becomes larger, the hydraulic oil 4 is stretched, and the inner chamber of the liquid capsule 14 generates a negative pressure. The negative pressure causes the valve plate group 15 on the left side of the partition 13 to be deformed, the lower three damping holes are opened (also see FIG. 4), and the hydraulic oil 4 in the second chamber 122 enters the inner chamber of the liquid capsule 14 through the damping holes. The hydraulic oil 4, when flowing toward the inner chamber of the liquid capsule 14, generates a leftward damping force on the partition 13, which slows down the leftward movement of the plunger 12 and has an effect of damping.

Referring again to FIG. 1, in another aspect of the present disclosure, a washing machine is provided, which includes a housing 2 and a drum 3 disposed in the housing 2. The drum 3 is supported on the housing 2 by two shock absorbers 1. Preferably, both the shock absorbers 1 are the shock absorbers 1 for a drum washing machine of the present disclosure described above. Of course, the number of shock absorbers 1 installed in the drum washing machine is not invariable, and three, four or more shock absorbers 1 may be disposed in the drum washing machine, as long as at least one of these shock absorbers 1 is the shock absorber 1 of the present disclosure as described above.

In addition, it should be pointed out that although the above preferred embodiments are described by taking a drum washing machine as an example, this is not intended to limit the scope of protection of the present disclosure, and it can be conceived by those skilled in the art that in addition to the drum washing machine, the present disclosure may also be applied to other laundry treatment devices; for example, it may also be applied to devices with the same or similar shock absorbing structure, such as pulsator washing machines, clothes dryers, and shoe washing machines.

Heretofore, the technical solutions of the present disclosure have been described in connection with the preferred embodiments shown in the drawings, but it can be easily understood by those skilled in the art that the scope of protection of the present disclosure is obviously not limited to these specific embodiments. Those skilled in the art can make equivalent changes or replacements to the related technical features without departing from the principle of the present disclosure. The technical solutions after the modification or replacement will fall within the scope of protection of the present disclosure.

1-10. (canceled)

11. A shock absorber, comprising:
a sleeve having a first chamber; and
a plunger which is slidably inserted into the first chamber of the sleeve;
wherein the first chamber is provided therein with a liquid capsule, and an open end of the liquid capsule is fixedly connected to the plunger; the plunger is provided therein with a second chamber which is provided with a plurality of damping holes at an end near the liquid capsule, and an inner chamber of the liquid capsule and/or the second chamber is filled with a fluid;
wherein the shock absorber further comprises at least one valve plate group comprising at least one a valve plate, the valve plate group covering at least one of the damping holes; and
wherein the valve plate group is capable of opening or closing the damping hole as the fluid flows.

12. The shock absorber according to claim 11, wherein the end of the second chamber near the liquid capsule is fixedly connected to or integrally provided with a partition, and the plurality of damping holes are disposed on the partition.

13. The shock absorber according to claim 12, wherein a thickness of the valve plate group gradually decreases from a center to an edge thereof.

14. The shock absorber according to claim 13, wherein the valve plate group comprises a plurality of valve plates, and the plurality of valve plates are stacked with each other in a direction away from the partition.

15. The shock absorber according to claim 14, wherein a surface area of each valve plate in the valve plate group gradually decreases in a direction away from the partition.

16. The shock absorber according to claim 15, wherein a projection of each of the valve plates in the valve plate group on the partition covers at least one of the damping holes.

17. The shock absorber according to claim 12, wherein each of the valve plates has a fan-blade structure or a quincunx-shaped structure.

18. The shock absorber according to claim 17, wherein the shock absorber comprises two said valve plate groups, and the two valve plate groups are disposed at two sides of the partition respectively.

19. The shock absorber according to claim 18, wherein the valve plate group is provided with a through hole, and the valve plate group is connected to the partition via a fastener passing through the through hole.

20. A laundry treatment device, comprising a housing and a washing drum disposed in the housing, the washing drum being supported in the housing through a plurality of shock absorbers, wherein at least one of the shock absorbers is the shock absorber according to claim 11.
